(19) United States
(12) Patent Application Publication
(10) Pub. No.: US 2020/0403192 A1
(43) Pub. Date: Dec. 24, 2020

(54) FLAME-RETARDANT UNIT

(71) Applicant: Cheng Uei Precision Industry Co., LTD., New Taipei City (TW)

(72) Inventor: JEN-KAI HUANG, New Taipei City (TW)

(21) Appl. No.: 16/684,451

(22) Filed: Nov. 14, 2019

(30) Foreign Application Priority Data
Jun. 24, 2019 (CN) 201920951670.X

(51) Int. Cl. H01M 2/02; H01M 2/10; A62D 1/00

(52) U.S. Cl. CPC H01M 2/0277; A62C 3/16; A62D 1/0064; H01M 2/1094

(57) ABSTRACT

A flame-retardant unit of the present invention includes a sticky coating and an outer layer. The sticky coating is made by a calendering process and made up of a mixture of a gel, a macromolecule material, a first additive and a second additive. The gel is made of silicon as a pure mixture without including any bridging agent. The macromolecule material, the first additive and the second additive are respectively disposed in the gel. The outer layer is disposed on a side of the sticky coating to provide a side of the flame-retardant unit with viscosity. The flame-retardant unit is made by means of the calendering process. The macromolecule material, the first additive and the second additive can be distributed homogeneously in the sticky coating, which provides the flame-retardant unit with stability and favourable effect on avoiding flame propagation and explosion, as well as on uniform heat transfer and dissipation.

### BACKGROUND OF THE INVENTION

### 1. Field of the Invention

The present application is based on, and claims priority from, China application number 201920951670.X, filed Jun. 24, 2019, the disclosure of which is hereby incorporated by reference herein in its entirety. The present invention generally relates to a flame-retardant unit, and more particularly to a flame-retardant unit with uniform heat transfer and dissipation, capable of avoiding flame propagation and explosion.

### 2. Related Art

In energy-dense lithium-ion battery cell module system, battery cells easily become unstable and lead to explosion under the influence of heat, shock, collision, etc. Because of closer stacking of the battery cells, as soon as one of the battery cells appears thermal runaway, the whole battery cell module would be readily burned and generate a heat that causes uncontrollable chain reactions or even an explosion, which leads to an unexpected result and a loss of the whole battery cell module.

With reference to FIG. 3, to avoid thermal runaway of the battery cells in the battery cell module, a conventional flame-retardant material 100′ is made up of a mixture of a carrier 11′, a macromolecule material 12′, a first additive 13′ and a second additive 14′. However, those components of the conventional flame-retardant material 100′ are in non-uniform distribution, therefore having unstable properties in avoiding flame spread. Furthermore, because the conventional flame-retardant material 100′ inherently lacks viscosity, it is needed to be applied with glue, which seems cumbersome in actual use.

Therefore, there is a need to provide a flame-retardant unit having viscosity and capable of avoiding flame propagation and preventing the battery cells in the battery cell module from thermal runaway for insuring security of the battery cell module.

### SUMMARY OF THE INVENTION

An object of the present invention is to provide a flame-retardant unit with uniform heat transfer and dissipation which has favourable effect on avoiding flame propagation and explosion.

To attain this, a flame-retardant unit of the present invention includes a sticky coating and an outer layer. The sticky coating is made by means of a calendering process and made up of a mixture of a gel, a macromolecule material, a first additive and a second additive. The gel is a soft material and is made of silicon that is present in a form of gummy material. The silicon remains a pure mixture without including any bridging agent. The macromolecule material, the first additive and the second additive are respectively disposed in the gel. The outer layer is disposed on a side of the sticky coating to provide a side of the flame-retardant unit with viscosity. The other side of the flame-retardant unit has no viscosity.

Accordingly, the gel is made of silicon that is present with an amount of 30-50 wt %.

Accordingly, the composite material composed of a nano silica and a nano clay is present in an amount of 3-10 wt %.

Accordingly, the first additive is aluminum hydroxide (Al(OH)₃.nH₂O).

Accordingly, the aluminum hydroxide is present in an amount of 40-60 wt %.

Accordingly, the second additive is magnesium hydroxide (Mg (OH)₂.nH₂O).

Accordingly, the magnesium hydroxide is present in an amount of 5-40 wt %.

Accordingly, the outer layer is a tape.

As above, the flame-retardant unit of the present invention is made by means of the calendering process. The macromolecule material, the first additive and the second additive can be distributed homogeneously in the sticky coating, which provides the flame-retardant unit with stability and favourable effect on avoiding flame propagation and explosion, as well as on uniform heat transfer and dissipation.

### BRIEF DESCRIPTION OF THE DRAWINGS

FIG. 1 is a schematic view showing components of a flame-retardant unit in accordance with the present invention;

FIG. 2 is a perspective view showing the flame-retardant unit in accordance with the present invention configured on a battery cell; and

FIG. 3 is a schematic view showing components of a conventional flame-retardant material.

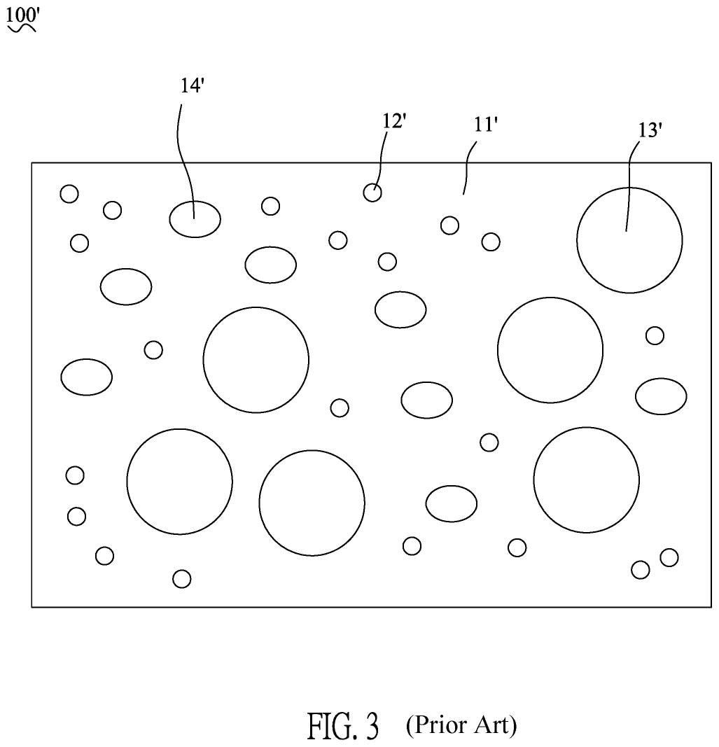

### DESCRIPTION OF THE PREFERRED EMBODIMENTS

In order to describe the technical contents, structural features, purpose to be achieved and the effectiveness of the present invention, the detailed description is given with schema below.

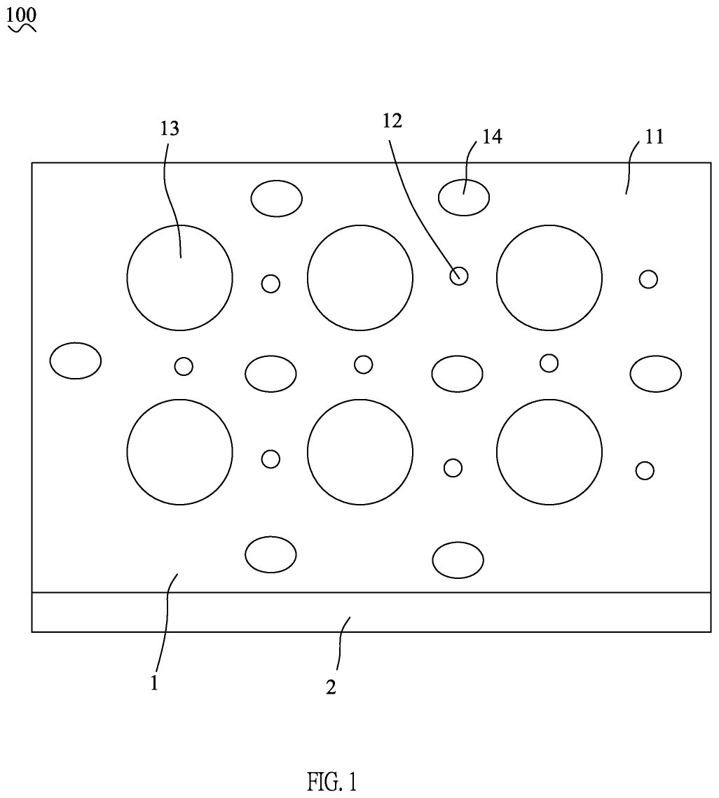

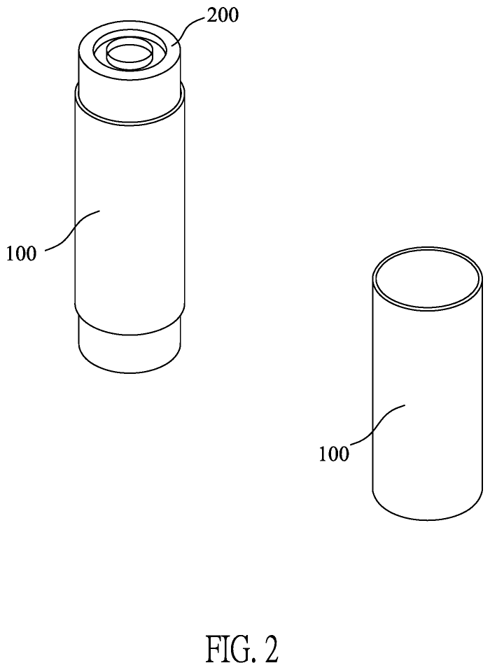

Referring to FIG. 1 and FIG. 2, a flame-retardant unit 100 is covered at an external surface of a battery cell 200, but is not limited thereto. The flame-retardant unit 100 can be applied in buildings or fabric. The flame-retardant unit 100 comprises a sticky coating 1 and an outer layer 2.

The sticky coating 1 is made up of a mixture of a gel 11, a macromolecule material 12, a first additive 13 and a second additive 14. The gel 11 is a soft material. More specifically, the gel 11 is made of silicon that is present in a form of gummy material with an amount of 30-50 wt %. Said silicon does not include any bridging agent and thus induces no crosslinking reaction, so the silicon is self-adhesive and is able to be pasted on the battery cell 200. Furthermore, because no chemical reaction occurs such as the crosslinking reaction, the silicon remains a pure mixture. As long as there is no functional damage, the silicon can be produced ceaselessly and is recyclable for reuse.

The macromolecule material 12 is disposed in the gel 11. The macromolecule material 12 has a thermal resistance property and involves thermal conducting materials. In this embodiment, the macromolecule material 12 is solid. The macromolecule material 12 is a composite material composed of nano silica (SiO₂) and nano clay. More specifically, the composite material composed of the nano silica and the nano clay is present in an amount of 3-10 wt %. When heated, the composite material gathers at an end in contact with a flame to form a block layer consisted of the nano silica and the nano clay for blocking the flame.

The first additive 13 is disposed in the gel 11. The first additive 13 is aluminum hydroxide (Al(OH)₃.nH₂O). The aluminum hydroxide is a solid material. More specifically, the aluminum hydroxide is present in an amount of 40-60 wt %. When heated to 130° C., the aluminum hydroxide decomposes into aluminum oxide (Al₂O₃) of less volume. Because of volume change, a phase change (from solid to gas) occurs, thereby forming voids in the flame-retardant unit 100 to block the flame.

The second additive 14 is disposed in the gel 11. The second additive 14 is magnesium hydroxide (Mg(OH)₂.nH₂O). The magnesium hydroxide is solid. More specifically, the magnesium hydroxide is present in an amount of 5-40 wt %. When heated to 150° C., the magnesium hydroxide decomposes into magnesium oxide (MgO) of less volume. Because of volume change, a phase change (from solid to gas) occurs, thereby forming voids in the flame-retardant unit 100 to block the flame as well.

Because the macromolecule material 12, the first additive 13 and the second additive 14 are solid, they are needed to be covered by the gel 11. After being processed by a processing equipment, the flame-retardant unit 100 of the present invention is formed in a piece shape.

The outer layer 2 is disposed on a side of the sticky coating 1 to provide a side of the flame-retardant unit 100 with viscosity. The other side of the flame-retardant unit 100 has no viscosity. More specific, the outer layer 2 is a tape. When the outer layer 2 is pasted on the side of the sticky coating 1, a stiffness of the flame-retardant unit 100 of the present invention is increased. Therefore, the flame-retardant unit 100 can steadily wrap the battery cell 200 or other products to facilitate processing operations.

The flame-retardant unit 100 is made by means of a calendering process, which starts by mixing the first additive 13 with the second additive 14 homogeneously to form a first mixture, then adding the gel 11 and a part of the first mixture of the first additive 13 and the second additive 14 into a mixing equipment, and after a period of time, adding the rest of the first mixture of the first additive 13 and the second additive 14 into the mixing equipment, so that a second mixture involving the gel 11, the first additive 13 and the second additive 14 that distribute homogeneously is provided.

Next, the macromolecule material 12 is mixed with the second mixture of the gel 11, the first additive 13 and the second additive 14 by mean of a rolling process during which the sticky coating 1 is pressed several times by a plurality of rollers to be shaped as a sheet-like form. The outer layer 2 is then pasted on a side of the sticky coating 1. The flame-retardant unit 100 is accomplished.

Therefore, the gel 11, together with the macromolecule material 12, the first additive 13 and the second additive 14 disposed therein, is pressed and sheared by the plurality of the rollers to increase plasticity, on a basis of which a sheet-like product is formed. By the calendering process, the macromolecule material 12, the first additive 13 and the second additive 14 can be distributed homogeneously in the gel 11 to provide the sticky coating 1 with uniform thermal conductivity, thereby stabilizing thermal conductivity of the flame-retardant unit 100 of the present invention. More specific, the flame-retardant unit 100 preferably is 0.5 mm in thickness. Furthermore, the gel 11 is a soft material, so the thickness, width and length of the sticky coating 1 can be customized.

Because the battery cell 200 easily becomes unstable and leads to explosion under the influence of heat, shock, collision, the flame-retardant unit 100 of the present invention with uniform heat transfer and dissipation is provided to cover the external surface of the battery cell 200, capable of protecting the battery cell 200 from flame propagation and explosion. The material combination described in this embodiment has a thermal conductivity of 1.02 W/m° C.

As above, the flame-retardant unit 100 of the present invention is made by means of the calendering process. The macromolecule material 12, the first additive 13 and the second additive 14 can be distributed homogeneously in the gel 11, which provides the flame-retardant unit 100 with stability and favourable effect on avoiding flame propagation and explosion, as well as on uniform heat transfer and dissipation.

What is claimed is:

1. A flame-retardant unit, including a sticky coating and an outer layer, the sticky coating made by means of a calendering process and made up of a mixture of a gel, a macromolecule material, a first additive and a second additive, wherein the gel is a soft material and is made of silicon that is present in a form of gummy material, the silicon remains a pure mixture without including any bridging agent, the macromolecule material, the first additive and the second additive are respectively disposed in the gel, the outer layer is disposed on a side of the sticky coating to provide a side of the flame-retardant unit with viscosity, and the other side of the flame-retardant unit has no viscosity.

2. The flame-retardant unit of claim 1, wherein the gel is made of silicon that is present with an amount of 30-50 wt %.

3. The flame-retardant unit of claim 1, wherein the macromolecule material is a composite material composed of nano silica (SiO₂) and nano clay.

4. The flame-retardant unit of claim 3, wherein the composite material composed of the nano silica and the nano clay is present in an amount of 3-10 wt %.

5. The flame-retardant unit of claim 1, wherein the first additive is aluminum hydroxide (Al(OH)₃.nH₂O).

6. The flame-retardant unit of claim 5, wherein the aluminum hydroxide is present in an amount of 40-60 wt %.

7. The flame-retardant unit of claim 1, wherein the second additive is magnesium hydroxide (Mg(OH)₂.nH₂O).

8. The flame-retardant unit of claim 7, wherein the magnesium hydroxide is present in an amount of 5-40 wt %.

9. The flame-retardant unit of claim 1, wherein the outer layer is a tape.
